(19) United States
(12) Patent Application Publication
(10) Pub. No.: US 2011/0107192 A1
(43) Pub. Date: May 5, 2011

(54) Authoring Tool and Method for Creating an Electrical Document

(75) Inventors: Shuzhi Ge, Singapore (SG); Xiangdong Chen, Singapore (SG); Xiaoyan Han, Singapore (SG)

(73) Assignee: NATIONAL UNIVERSITY OF SINGAPORE, (SG)

(21) Appl. No.: 11/908,251

(22) PCT Filed: Jan. 3, 2006
(86) PCT No.: PCT/US06/00052

§ 371 Date: Oct. 28, 2008

(51) Int. Cl. G06F 17/00

(52) U.S. Cl. 715/202

(57) ABSTRACT

An authoring tool for creating an electronic document, a method for creating the electronic document, a data storage medium for instructing a computer to execute the method for creating the electronic document and a data storage medium for instructing a computer to display the electronic document. The authoring tool comprises; a template module for selecting a template for the electronic document, the template comprising one or more display pages; a content management module for arranging one or more media files on each display page with selected interrelationships between the media files; a generating module for creating an electronic page file for each display page, wherein the media files are embedded in the respective electronic page files based on the selected interrelationships and in a manner such that each electronic page file includes interrelationship data defining the interrelationships of the embedded media files in said each electronic page file with other media files in said each electronic page file and with other media files in other electronic page files of the electronic document; and a binding module for electronically binding the respective electronic page files so as to create the electronic document.

### FIELD OF THE INVENTION

The present invention relates broadly to an authoring tool and method for creating an electronic document, to a data storage medium having stored thereon computer code means for instructing a computer to execute a method for creating an electronic document, and to a data storage medium having stored thereon computer code means for instructing a computer to display an electronic document

### BACKGROUND

Existing electronic “books” (“e-books”) are essentially printed books “transferred” into electronic form. Existing e-book authoring tools typically provide word processing-type functions and simple insert or import functions to include objects such as pictures in the flow of the text. As a result, present e-books retain the characteristics of a printed book. That is, the existing e-book is more or less a “direct” conversion of media presented in a printed form to media presented in an electronic form, with some inherent functionality such as search functions.

On the other hand, the attraction of books, both in printed and in electronic form, lies to a large extent in the stimulation the content provides to the reader, such as creating a visual perception of the content in the readers mind. However, existing e-books and the associated authoring tools have so far failed to significantly increase that general attraction of books. As a result, printed books have maintained the preferred option for many readers, since the added features of existing e-books over printed books appear to be out weight by the still superior portability, mobility and usability of printed books.

A need therefore exists to provide an e-book and associated authoring tool that seek to address at least one of the abovementioned disadvantages of existing e-books.

### SUMMARY OF THE INVENTION

According to a first aspect of the invention, there is provided an authoring tool for creating an electronic document, the authoring tool comprising: a template module for selecting a template for the electronic document, the template comprising one or more display pages; a content management module for arranging one or more media files on each display page with selected interrelationships between the media files; a generating module for creating an electronic page file for each display page, wherein the media files are embedded in the respective electronic page files based on the selected interrelationships and in a manner such that each electronic page file includes interrelationship data defining the interrelationships of the embedded media files in said each electronic page file with other media files in said each electronic page file and with other media files in other electronic page files of the electronic document; and a binding module for electronically binding the respective electronic page files so as to create the electronic document.

The interrelationships may comprise dynamic and static interrelationships between the media files.

The dynamic interrelationships may comprise trigger event based interrelationships, wherein one or more causable actions associated with one media file may be invoked based on trigger events.

The trigger events may include one or more of a group consisting of a time based, a mouse click based, a media file or portion of media file detection based, and a key stroke based trigger event.

The media files may include one or more of a group consisting of a text file, a picture file, a video file, a 3-D graphics file, a sound file, and a multi-media file.

According to a second aspect of the invention, there is provided a method for creating an electronic document, the method comprising the steps of: selecting a template for the electronic document, the template comprising one or more display pages; arranging one or more media files on each display page with selected interrelationships between the media files; creating an electronic page file for each display page, wherein the media files are embedded in the respective electronic page files based on the selected interrelationships and in a manner such that each electronic page file includes interrelationship data defining the interrelationships of the embedded media files in said each electronic page file with other media files in said each electronic page file and in with other media files in other electronic page files of the electronic document and electronically binding the respective electronic page files so as to create the electronic document.

According to a third aspect of the invention, there is provided a data storage medium having stored thereon computer code means for instructing a computer to execute a method for creating an electronic document, the method comprising the steps of: selecting a template for the electronic document, the template comprising one or more display pages; arranging one or more media files on each display page with selected interrelationships between the media files; creating an electronic page file for each display page, wherein the media files are embedded in the respective electronic page files based on the selected interrelationships and in a manner such that each electronic page file includes interrelationship data defining the interrelationships of the embedded media files in said each electronic page file with other media files in said each electronic page file and in with other media files in other electronic page files of the electronic document; and electronically binding the respective electronic page files so as to create the electronic document.

According to a fourth aspect of the invention, there is provided a data storage medium having stored thereon computer code means for instructing a computer to display an electronic document, the electronic document comprising: one or more display pages; and an electronic page file for each display page, wherein media files are embedded in the respective electronic page files based on selected interrelationships and in a manner such that each electronic page file includes interrelationship data defining the interrelationships of the embedded media files in said each electronic page file with other media files in said each electronic page file and with other media files in other electronic page files of the electronic document; wherein the respective electronic page files are bound together so as to form the electronic document.

### BRIEF DESCRIPTION OF THE DRAWINGS

This present invention is now be described by way of non-limiting examples, with reference to the accompanying drawings, in which:

FIG. 1 shows a graphic user interface of an electronic book authoring tool.

FIG. 2A shows the main processing platform of the electronic authoring tool and illustrates data flow between each of the platform components.

FIG. 2B shows a schematic diagram of the Media Filtering Modules and the Media Presentation Modules of the electronic authoring tool.

FIG. 3 illustrates the hierarchy of a book data structure and the hierarchy of book properties provided by the Book-Type Generation Modules for storing electronic document information.

FIGS. 4A to 4E respectively illustrate several uses of Book-type Generation Modules.

FIGS. 5A to 5C illustrates how the document layout tool of the Book-type Generation Modules can create new electronic document templates or modify existing electronic document templates through the use of a vertex cage.

FIG. 6 shows a flowchart of an algorithm employed when the Loading and Formatting Modules are invoked, the purpose being to convert loaded external media into data format used by the electronic authoring tool.

FIG. 7 illustrates a schematic of basic element file types being converted into respective PEM data objects.

FIG. 8 illustrates a schematic of compound file types being decomposed into basic element file types.

FIG. 9 illustrates one use of Media Loading and Formatting Modules.

FIG. 10 shows the arrangement of multimedia objects on display pages of an electronic document through the Content Management Modules.

FIG. 11 shows a sub-content layer provided by the Content Management Modules.

FIG. 12 shows Actions and Events associated with an object in an electronic document.

FIG. 13 illustrates several uses of the Action and Event Management Modules.

FIG. 14 illustrates how the Media Filtering Modules work in conjunction with the Action and Event Management Modules.

FIG. 15 illustrates a flowchart of an algorithm used by the Action and Event Management Modules.

FIG. 16 illustrates how the Viewing Enhancement Modules of the Media Presentation Modules enlarge text.

FIGS. 17A to 17C show how fish-eye zoom is performed using the Viewing Enhancement Modules of the Media Presentation Modules.

FIGS. 17D and 17E show how fish-eye zoom can be combined with parallel zoom to enlarge text.

FIG. 18A illustrates the fast multi page flip style of the Media Presentation Modules in use.

FIG. 18B shows a flowchart of an algorithm employed by the Artificial Intelligence Data Filter of the Loading and Formatting Modules.

FIGS. 19A to 19D illustrate how the Page Flipping Module of the Media Presentation Module is used to modulate the manner in which each electronic document display page flips through weighted vertex manipulation.

FIG. 20 shows a graphic user interface provided by the Content Management Modules.

FIG. 21 shows a graphic user interface depicting a visual electronic storage object in the form of an electronic library.

FIG. 22 shows a graphic User interface depicting a visual storage object in the form of an electronic table.

FIG. 23 is a schematic drawing illustrating a computer system for implementing the authoring tool of FIG. 2A.

### DESCRIPTION OF EMBODIMENTS OF THE INVENTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “load”, “embed”, “create”, “render”, “import”, “export”, “action”, “effect”, “invoke”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

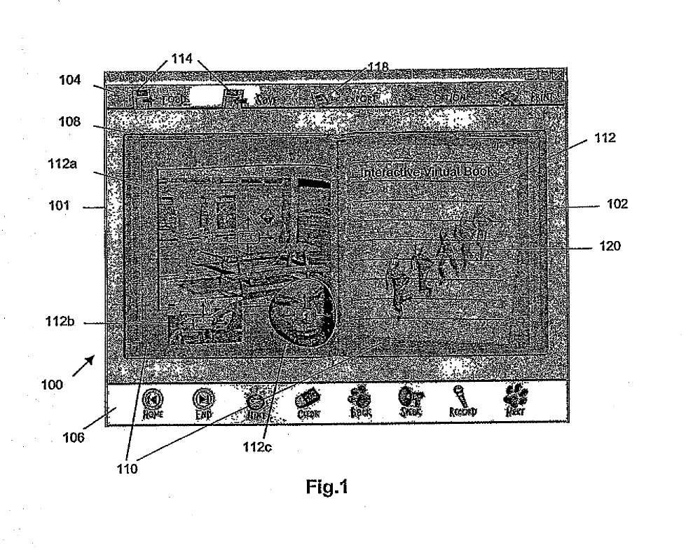

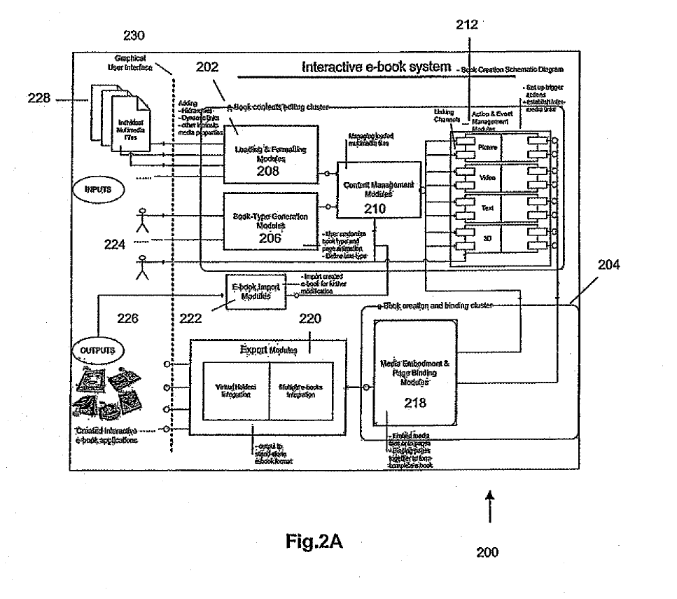

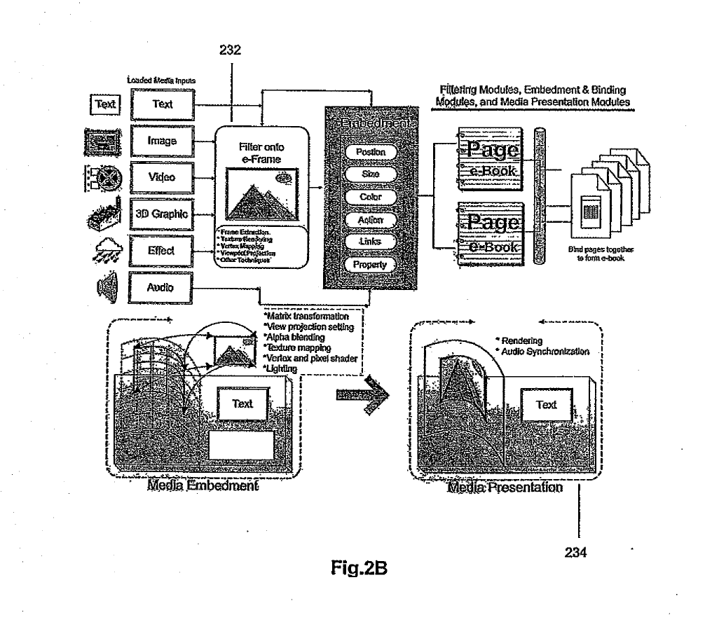

FIG. 1 shows a graphic user interface 100 provided by an electronic authoring tool 200 (FIG. 2) built in accordance with one embodiment of the present invention.

The graphic user interface 100 comprises a main window 101 with an upper toolbar 104 and a lower toolbar 106 that are respectively aligned above and below a display window 102. The upper and lower toolbars 104 and 106 comprise a plurality of icons 114. Each icon 114 provides access to the functions performed by various modules of the electronic authoring tool 200 (FIG. 2). Thus, when a command is executed through the operation of an icon 114, the module associated with the icon 114 is invoked and any perceivable response displayed in the display window 102.

Turning now to FIGS. 2A and 2B, the electronic authoring tool 200 includes, Book-type Generation Modules 206, Loading and Formatting Modules 208, Content Management Modules 210, Action and Event Management Modules 212, Media Embedment and Page Binding Modules 218, Export Modules 220, Import Modules 222, Media Filtering Modules 232 and the Media Presentation Modules 234.

The electronic authoring tool 200 provides an electronic document of PEM data format. The electronic authoring tool 200 provides tools through the use of the appropriate Modules mentioned in the previous paragraph to create interrelationships between the objects (such as text elements, picture and video files) so that an interactive electronic document is produced. Existing data file formats that are imported by the electronic authoring tool 200 and converted into the PEM data format can incorporate additional functionality beyond the original properties of the existing data file formats. These additional functionality include interrelationships between other PEM data objects, filters and a sub-content layer for a user to incorporate functionality in the objects within the electronic document. The electronic authoring tool 200 also facilitates more efficient presentation of information such as a fast multi page tool to quickly access the contents of an electronic document and thereby reduces the amount of computer processing resources used.

One or more modules of the electronic authoring tool 200 are invoked to create a portion of an electronic document 226. For example, to load and embed external media files 228, such as text and multimedia files, sound and video clips and pictures within each display page 110 (FIG. 1) being created, the Loading and Formatting Modules 208 and subsequently the Media Embedment and Page Binding Modules 218 will be invoked. Typical external media 228 that can be loaded and embedded include:
electronic picture files with data format such as “jpg”, “bmp”, “png” and “gif”;
text files with data formats such as “doc”, “pdf”, “xml”, “html”, “txt” and “rtf”;
video files with data formats such as “avi” and “mpg”;
sound files with data formats such as “way”, “mp3” and “midi”; and
3D animation files with data formats such as “3ds” and “x”.

The embedment is done through a multi-layer approach. Controls, effected by the Media Presentation Modules 234, are available to modulate the level of transparency, overlay, rendering and shading effects applied to each layer. By controlling the level of rendering applied to a first medium, such as a first picture, on a first layer and the level of rendering applied to a second medium, such as a second picture, on a second layer, the two media can be perceived to be “blending” in with one another.

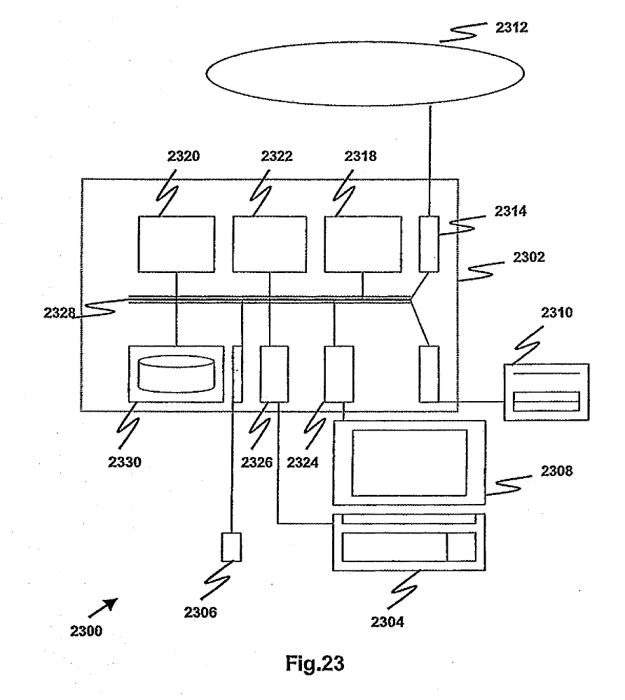

The electronic authoring tool 200 can be implemented on a computer system 2300, schematically shown in FIG. 23. It may be implemented as software, such as a computer program being executed within the computer system 2300, and instructing the computer system 2300 to conduct the method of the example embodiment.

The computer system 2300 comprises a computer module 2302, input modules such as a keyboard 2304 and mouse 2306 and a plurality of output devices such as a display 2308, and printer 2310.

The computer module 2302 is connected to a computer network 2312 via a suitable transceiver device 2314, to enable access to e.g. the Internet or other network systems such as Local Area Network (LAN) or Wide Area Network (WAN).

The computer module 2302 in the example includes a processor 2318, a Random Access Memory (RAM) 2320 and a Read Only Memory (ROM) 2322. The computer module 2302 also includes a number of Input/Output (I/O) interfaces, for example I/O interface 2324 to the display 2308, and I/O interface 2326 to the keyboard 2304.

The components of the computer module 2302 typically communicate via an interconnected bus 2328 and in a manner known to the person skilled in the relevant art.

The application program is typically supplied to the user of the computer system 2300 encoded on a data storage medium such as a CD-ROM or flash memory carrier and read utilising a corresponding data storage medium drive of a data storage device 2330. The application program is read and controlled in its execution by the processor 2318. Intermediate storage of program data maybe accomplished using RAM 2320.

Returning to FIG. 1, as an illustration of how the electronic authoring tool modules are used, a book template 108 has been loaded using the Book-type Generation Modules 206 (FIG. 2) and displayed in the display window 102. The book template 108 comprises one or more display pages 110. Pictures 112a, 112b and 112c have been displayed on the left display page 110 using the Loading and Formatting Modules 208 (FIG. 2). The pictures 112b and 112c exist on layers that are higher than the layer the picture 112a resides on. A multimedia file 120 (invoked by the Loading and Formatting Modules 208 of FIG. 2), running in real time, of a man in several stages of motion has been displayed on the right display page 110. For each stage of motion, a different degree of transparency has been applied using the Media Presentation Modules 234 (FIG. 2A).

After the entire layout on every display page 110 of the book template 108 has been decided, the Media Embedment and Page Binding Modules 218 (FIG. 2) will be invoked to embed all media into their respective display page 110 and subsequently bind all the display pages 110 together. Finally, the Export Modules 220 (FIG. 2) will be invoked to obtain a finished electronic document 226. The Export Modules 220 also facilitates, if so configured by the creator of the book template 108, for the text 122 to be editable by other parties, for example a person who is reading the finished electronic document and wants to make comments in the text 122.

Thus, in the above manner, the electronic authoring tool provides a mechanism to produce an electronic document comprising a template 108. The template will have several display pages 110, with the capability of placing media items such as the pictures 112a, 112b and 112c and the multimedia file 120 onto each of the display pages 110.

FIG. 2A shows the main processing platform of an electronic authoring tool 200 and illustrates data flow between each of the platform components.

The main platform components of the electronic authoring tool 200 comprise a content editing cluster 202 and a creation and binding cluster 204.

The content editing cluster 202 further comprises the Book-type Generation Modules 206, the Loading and Formatting Modules 208, the Content Management Modules 210 and the Action and Event Management Modules 212.

The creation and binding cluster 204 further comprises the Media Embedment and Page Binding Modules 218.

Other components of the electronic authoring tool 200 include the Export Modules 220, the Import Modules 222, the Media Filtering Modules 232 (FIG. 2B) and the Media Presentation Modules 234 (FIG. 2B).

The Book-Type-Generating Modules 206, the Loading and Formatting Modules 208, the Content Management Modules 210, the Action and Event Management Modules 212, the Media Embedment and Page Binding Modules 218, the Export Modules 220 and the Import Modules 222 are for the creation of the electronic document 226.

The Media Filtering modules 232 (FIG. 2B) and the Media Presentation Modules 234 (FIG. 2B) are for the presentation of the electronic document 226.

The Book-type Generation Modules 206 provide two authoring tools and a document layout tool for a user 224.

The first authoring tool, referred to as the document template creator, allows the user 224 to create a new template for his electronic document 226.

The second authoring tool of the Book-type Generation Modules 206, referred to as the document template selector, allows the user 224 to select pre-defined electronic templates and therefore concentrate on creation of the electronic document 226 content. It will also be appreciated that new templates created by the document template creator tool are also made available to the document template selector tool.

The document template selector tool is particularly useful when the user 224 is mainly interested in preparing a report as the Book-type Generation Modules 206 will retain, in the final created electronic document 226, the layout the user 224 employed when he was preparing the electronic document 226, Thus, the user 224 can concentrate on writing his report, without worrying whether there will be content alignment changes in the final created electronic document. If desired, the document template selector tool can also provide a step-by-step guide to assist the user 224 in aligning and formatting the contents on each page of the electronic document 226 to be created. For instance, a “poem” template will guide the user 224 to create a book of poems, while a “recipe” template will guide the user 224 to easily create a cooking manual.

The document layout tool of the Book-type Generation Modules 206 allows the user 224 to customise pre-defined templates.

When the final template of the electronic document 226 has been selected, the user 224 can also use the Book-type Generation Modules 206 to make further customisations, such as the manner in which each page of the electronic document 226 proceeds to the next.

The Loading and Formatting Modules 208 of the electronic authoring tool 200 convert external media 228 of different file types into a file type that is compatible with the electronic authoring tool 200 when these external media 228 are loaded by the electronic authoring tool 200. Hierarchies, dynamic links and other intrinsic media properties are added, and certain original media properties are amended.

Hierarchies are priority levels that can be applied to an object, a group of objects, or even a portion of an object so that different portions of the same object can have different hierarchies. By suitable application of hierarchies to different objects in an electronic document, real-time media processing is made more efficient. By assigning different hierarchies to different objects within an electronic document, a dynamic interrelationship can be created between the different objects concerned. For instance, when a higher hierarchy is assigned to a first image and a lower hierarchy is assigned to a second image, moving the first image will cause a corresponding movement to the second image. However, moving the second image will not cause a movement in the first image.

Dynamic links serve as signals embedded in an object in the electronic that once activated cause a separate pre-programmed event to occur. Dynamic links are used by the Action and Event Management Modules 212 and will be described in greater detail with reference to reference to FIGS. 12 to 15.

Intrinsic media properties refer to properties added Into the original data structure of objects imported into the electronic document. For example, an animated 2D media file may have a “speed” property included as part of its new data structure, so that when the animated media file is embedded into the electronic document, its animation speed can be controlled by its new intrinsic “speed” property.

As another example of how the Loading and Formatting Modules 208 amend original media properties, when an electronic picture file with data format “bmp” is loaded by the electronic authoring tool 200 and passed through the Loading and Formatting Modules 208, it no longer remains as data format “bmp”, but rather data with a texture format having surface modulation properties.

Thus, the Loading and Formatting Modules 208 of the electronic authoring tool 200 provides mechanisms for loading external media that include:
electronic picture files with data format such as “jpg”, “bmp”, “png” and “gif”;
text files with data formats such as “doc”, “pdf”, “xml”, “html”, “txt” and “rtf”;
video files with data formats such as “avi” and “mpg”;
sound files with data formats such as “wav”, “mp3” and “midi”; and
3D animation files with data formats such as “3ds” and “x”
   and converting these formats into a format compatible with the electronic authoring tool 200.

As mentioned earlier, embedment of external text files and external multimedia files 228 is done through a multilayer approach, where controls are available to modulate the level of transparency, overlay, rendering and shading effects applied to each layer. The Loading and Formatting Modules 208 enable this multilayer capability by allowing the layers to be arranged in a hierarchical relationship. Further, the Loading and Formatting Modules 208 provide an index in respect of the rendering and transparency levels applied to each layer.

The Content Management Modules 210 of the electronic authoring tool 200 provide the user 224 with a graphic user interface 230. The graphic user interface 230 allows the user 224 to manage and arrange external media 228 that is to be placed in an electronic document 226.

In addition, the Content Management Modules 210 allow the user 224 to add other objects such as text-boxes, drawing pads and 3D models and arrange these objects on any of the display pages as he desires.

Other functions provided by the Content Management Modules 210 include text editing tools such as word error checking, change tracing, selection of different text font sizes, book marking, text alignment and picture zooming. These other functions are available to the user 224 when he either creates a new electronic document template or when he creates an electronic document from an existing template.

Typically, at this stage where the user 224 is loading and arranging external media 228 on each page of the document template chosen, the Book-type Generation Modules 206, the Loading and Formatting Modules 208 and the Content Management Modules 210 are invoked in parallel.

After managing and arranging external media 228 that is to be placed in an electronic document 226, the user 224 can create interrelationships between all the objects in the electronic document 226, such as the displaying of a video clip when a particular word in the electronic document 226 is selected. These interrelationships are effected through the Action and Event Management Modules 212 so that selected objects in the finished electronic document 226 are interactive. The Action and Event Management Modules 212 are described in further detail with reference to FIGS. 12 to 15.

At this stage, all the loaded media 228 placed on each display page of the electronic document 226 are still detached from the display page and still exist as separate data files. The Media Embedment and Page Binding Modules 218 of the electronic authoring tool 200 are used to embed and merge all display page contents onto each of their respective display pages of the electronic document 226. The properties associated with each display page content are then fixated on each of the display pages.

The Export Modules 220 of the electronic authoring tool 200 enable the user to output the electronic document 226 as a data file type “pmb” which can be opened and edited in another computer with the electronic authoring 200 installed. Each created electronic document 226 can be separated into several electronic documents 226 or conversely, several electronic documents 226 can be combined into one single electronic document 226. The Import Modules 222 are used to open the electronic document 226.

FIG. 2B shows a schematic diagram of the Media Filtering Modules 232 and the Media Presentation Modules 234 of the electronic authoring tool 200 (FIG. 2A).

The Media Filtering Modules 232 of the electronic authoring tool 200 (FIG. 2A) scan all contents that are present inside an electronic document to discover whether any of to these contents have an associated Action and Event If the Media Filtering Modules 232 do not find a match, then all the contents of the electronic document will simply be passed without any action taken. The concept of the Action and Event will be described later with reference to FIGS. 12 to 15 with an appropriate example.

The Media Presentation Modules 234 of the electronic authoring tool 200 (FIG. 2A) further include three modules (not shown), a Rendering Component, a Viewing Enhancement and a Page Flipper.

The Rendering Component Module allows a user to adjust rendering levels values of all the multimedia objects placed in the electronic document to be created: In this regard, the Rendering Component Module provides tools such as color channels (e.g. alpha channels) for controlling the rendering of loaded pictures or electronic external multimedia files and tools such as vertex and pixel shader for controlling the rendering of three dimensional graphics. These tools allow the user to control the transparency, overlay and apply shading effects onto the loaded external multimedia files. The Rendering Component Module can also blend the external multimedia files in real-time.

The Viewing Enhancement Module of the Media Presentation Modules 234 allows the user to enlarge text in the electronic document.

The Page Flipper Module of the Media Presentation Modules 234 is applied to each page of the electronic document and serves to simulate the actual turning of a page of a physical book. Under the Page Flipper Module, two page flipping styles are available, namely a slow single page flip and a multi page flip.

The slow single page style is used when the electronic document is read for the first time, where all of the details on each page may be important to the reader.

The fast multi page flip style is used when specific information or a specific page is desired to be located.

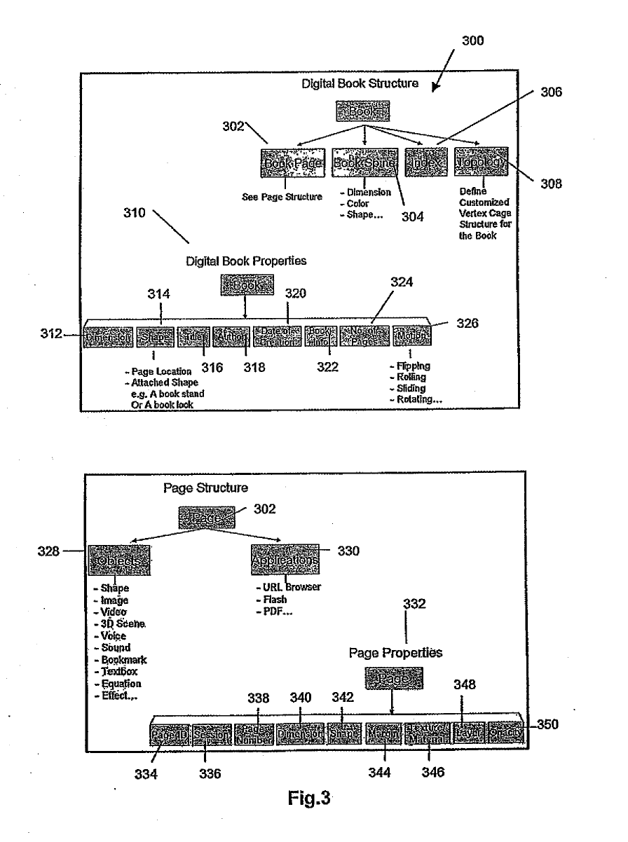

FIG. 3 illustrates the hierarchy of a book data structure 300 and the hierarchy of book properties 310 provided by the Book-Type Generation Modules 206 (FIG. 2A) for storing electronic document information.

The book data structure 300 comprises electronic document information such as book page 302, book spine 304, index 306 and topology 308.

The book properties 310 comprise electronic document information such as dimension 312, shape 314, title 316, author 318, date of creation 320, book information 322, number of pages 324 and motion 326.

Each book page 302 further comprises media objects 328 and embedded applications 330. The media objects 328 can include two dimensional and three dimensional shapes, text, images, textures, videos, sound, voice, music, three dimensional scenes, animation, special effects, borders, advertisements and controls. The embedded applications 330, such as an Internet web browser and a two dimensional/three dimensional viewer can respectively be used to navigate the Internet and open two dimensional/three dimensional files. These media objects 328 and embedded applications 330 exist on layers which are combined to form an interactive electronic document.

Each book page 302 also has properties 332 comprising electronic document information such as page ID 334, session 336, page number 338, dimension 340, shape 342, margin 344, texture/material 346, layer 348 and opacity 350.

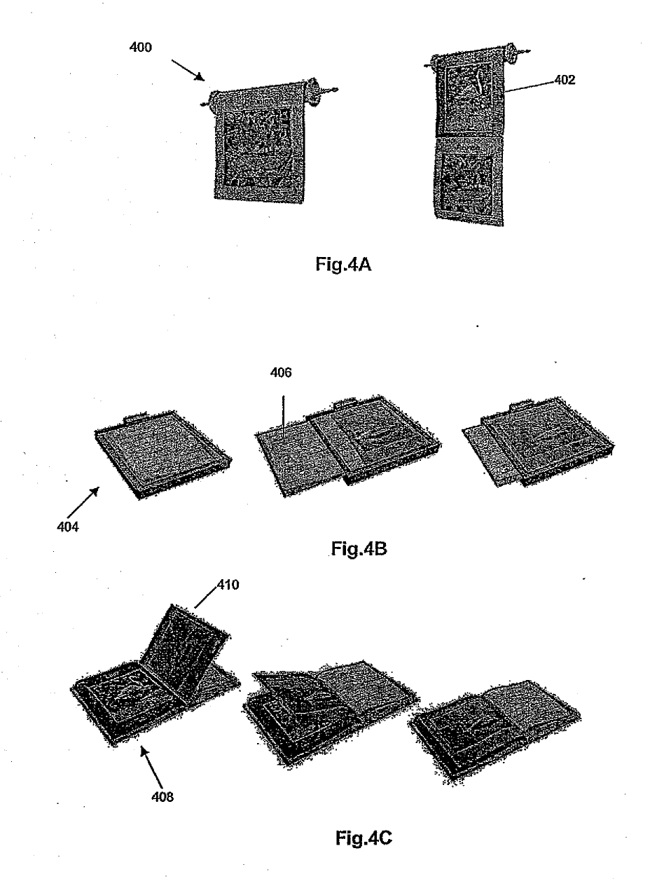

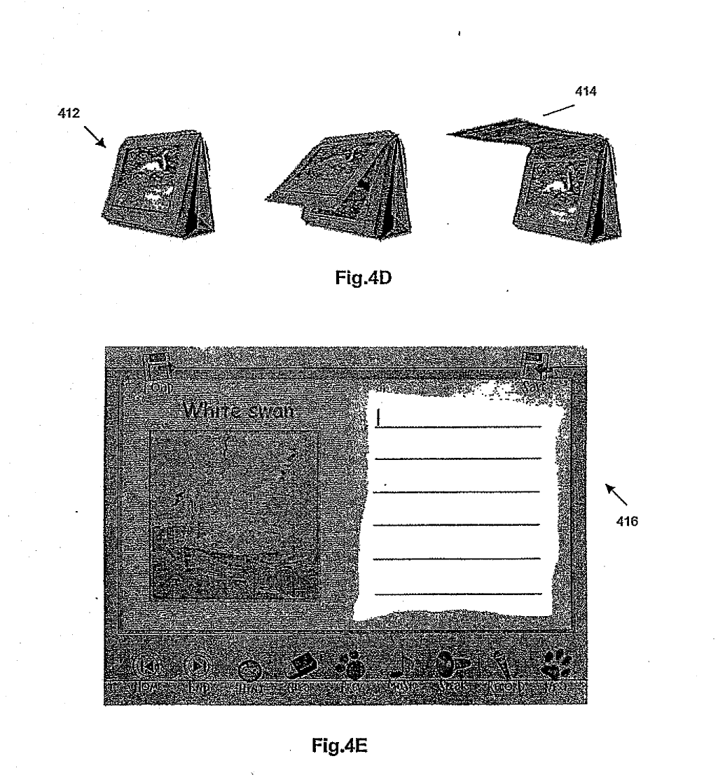

By indexing electronic document information as illustrated in FIGS. 3 and 4, retrieval of electronic document information is more effective and faster.

FIGS. 4A to 4E respectively illustrate several uses of the Book-type Generation Modules 206 (FIG. 2A). The Book-type Generation Modules 206 (FIG. 2A) will be invoked when a user wants an electronic document 400 to have a scroll template, an electronic document 404 to have a sliding card template, an electronic document 408 to have a “traditional” book template or an electronic document 412 to have an upright calendar template. The Book-type Generation Modules 206 (FIG. 2A) can also customise the speed in which each pages 402, 406, 410 and 414 of the electronic documents 400, 404, 408 and 412 proceed to the next page. A further customisation the Book-type Generation Modules 206 (FIG. 2A) can perform is shown in FIGS. 4A, 40 and 4D, where the angle in which each page 402, 410 and 414 bends when the respective page 402, 410 and 414 is turned can be adjusted. Such customisation can be done in “real time”. In contrast to existing prior art electronic authoring tools, “real time” customisation is not available.

While three dimensional electronic documents 400, 404, 408 and 412 have been presented in FIGS. 4A to 4D, it will be appreciated that the electronic authoring tool 200 (FIG. 2A) also allows for the creation of a two dimensional electronic document 416, as illustrated in FIG. 4E.

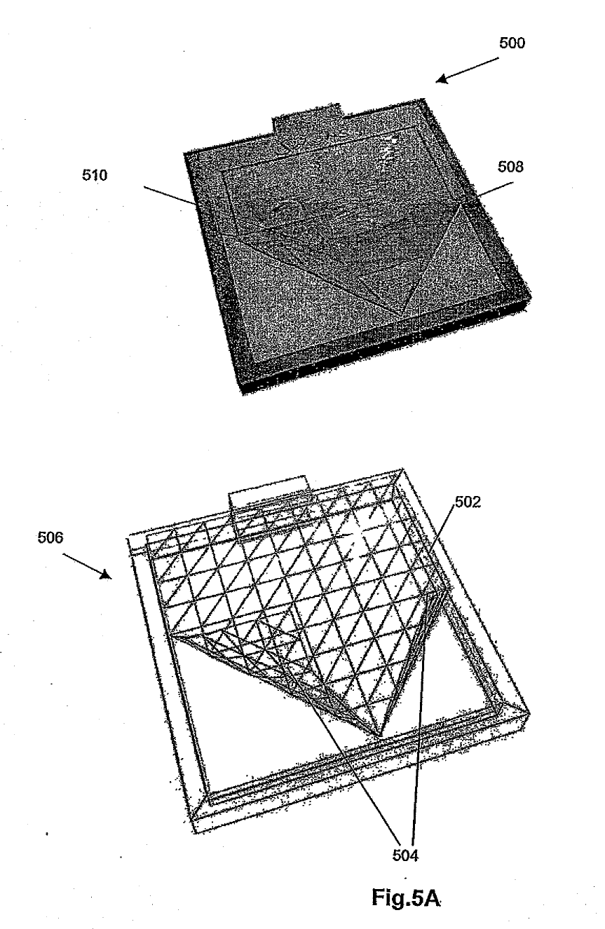

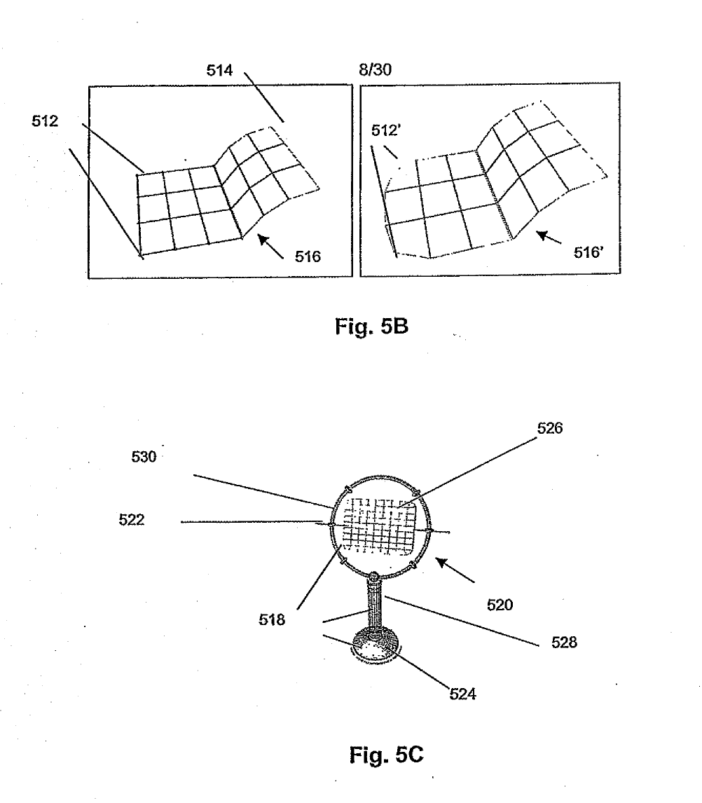

FIGS. 5A to 5C illustrates how the document layout tool of the Book-type Generation Modules 206 (FIG. 2A) can create new electronic document templates or modify existing electronic document templates through the use of a vertex cage.

FIG. 5A shows a vertex cage 502 created over an entire frame 506 of an electronic document template 500. The vertex cage 502 defines control points 504 over the entire frame 506. A user can then work on the control points 504 so as to deform the original shape of the frame 506. The Book-type Generation Modules 206 (FIG. 2) also allow the sequence in which edges 508 and 510 are folded to be changed.

FIG. 5B shows a further illustration of the shape of an electronic document 516 being deformed through the use of a vertex cage 514. A user has worked on the control points on the edges 512 of the electronic document 516 so that the resulting electronic document 516′ has edges 512′ having a different shape.

FIG. 5C illustrates how vertex cages 518 can be created on each portion of an electronic document 520 with an arbitrary mesh structure. The mesh structure of the electronic document 520 comprises a base portion 524, a support 528 and a page display segment 530. Each page 526 of the electronic document 520 has a central s axis 522 and the central axis 522 lies along the centre of the page display segment 530. Both ends of the central axis 522 engage the page display segment 530 so that each page 526 can rotate about the central axis 522.

While FIGS. 5A to 5C illustrate the vertex cages 502, 514 and 518 being created in a three dimensional context, the vertex cages 502, 514 and 518 can also be simulated in two dimensions (not shown).

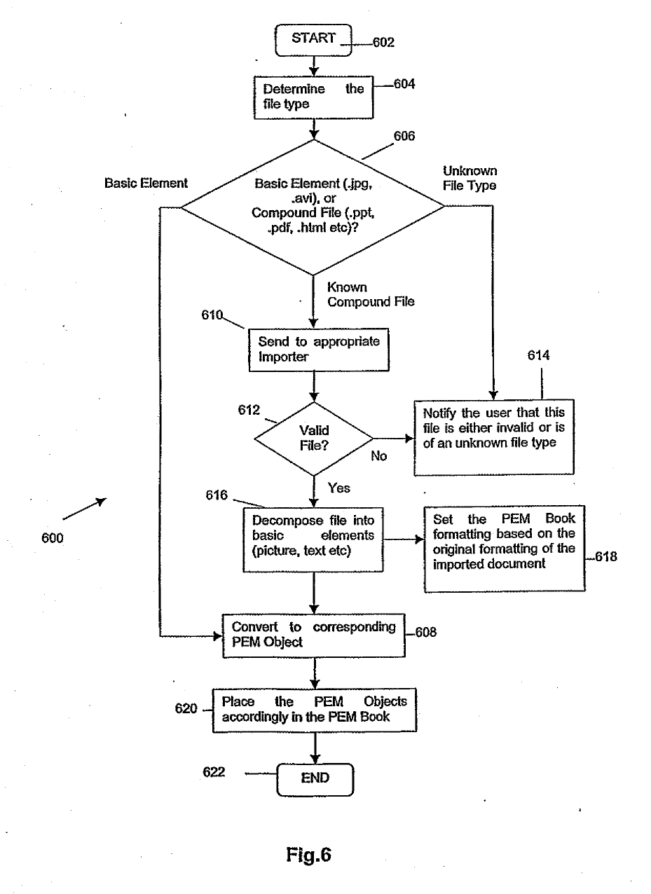

FIG. 6 shows a flowchart of an algorithm 600 employed when the Loading and Formatting Modules 208 (FIG. 2A) are invoked, the purpose being to convert loaded external media into data format used by the electronic authoring tool 200 (FIG. 2).

The Loading and Formatting Modules 208 (FIG. 2A) are invoked when a user loads external media at step 602. At step 604, it is determined whether the loaded external media is of a known file type or an unknown file type. Known file types further include files of a basic element type or a compound file type.

Loaded external media of basic element type are files that have only data of a single format, such as “jpg”, “bmp” or “x”. Loaded external media of compound file type are files that incorporate one or more basic elements.

When a basic element file type is detected at step 606, the algorithm 600 proceeds to step 608. At step 608 the basic element file type is directly converted into a PEM data object, the data format used by the electronic authoring tool 200 (FIG. 2A). The user can then in step 620 modify the content of each PEM data object or accordingly arrange one or PEM data objects on the electronic document to be created.

Returning to step 606, the algorithm 600 proceeds to step 610 when a compound file type is detected. At step 610 the compound file type is sent to an appropriate importer, such as an available Application Programming interface (API). The appropriate importer will then determine at step 612 whether the compound file type is of a valid data format. If the compound file type is of an invalid data format, then the user will be accordingly notified in step 614. On the other hand, if the compound file type is of a valid data format, then the compound file type will be decomposed into its basic elements in step 616.

A first output of step 616 is basic element file types. Each of the basic element file types is converted to a corresponding PEM data object in step 608.

A second output of step 616 is information regarding the original spatial arrangement of content within the original compound file type, indicated as step 618. This original to spatial arrangement of content information can be used by the algorithm 600 to have the PEM data objects spatially arranged in the same manner as the original compound file type. It will be appreciated that if the user so desires, he can maintain the original spatial arrangement or modify the spatial arrangement in step 620.

Returning to step 606, the algorithm 600 proceeds to step 614 when an unknown file type is detected. The user will thus be accordingly notified.

After step 620 is executed, the algorithm 600 comes to an end at step 622.

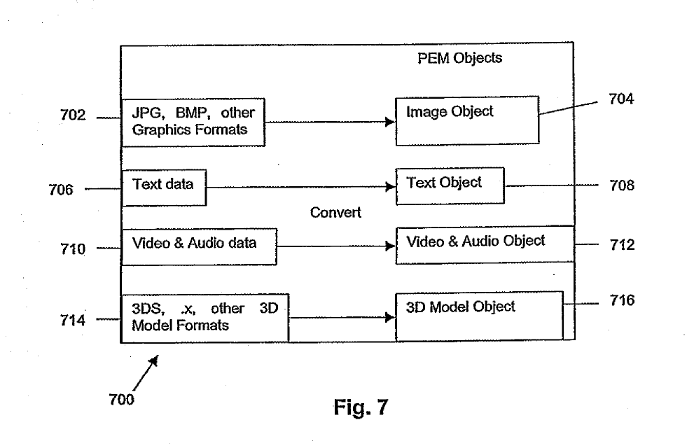

FIG. 7 illustrates a schematic 700 of basic element file types being converted into respective PEM data objects.

Basic element file types such as graphic data 702, text data 706, video and audio data 710, three dimensional models and animation files 714 are respectively converted by the Loading and Formatting Modules 208 (FIG. 2A) at step 608 (FIG. 6) into the PEM data objects of image object 704, text object 808, video and audio object 712 and three dimensional model object 716 respectively.

As compared to the original basic element file types, additional properties such as three dimensional space properties (e.g.: effects, lighting and shading), hierarchy, dynamic links, along with action and events can be integrated into PEM data objects.

For example, after a “bmp” graphic data 702 is converted to an image object 704, the resulting image object 704 has the capability to support bump mapping, shadowing, and three dimensional animation.

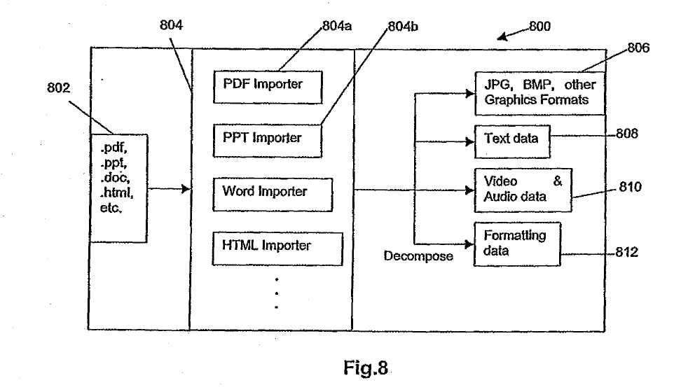

FIG. 8 illustrates a schematic 800 of compound file types 802 being decomposed into basic element file types.

The decomposition is effected by the Loading and Formatting Modules 208 (FIG. 2A) at step 608 (FIG. 6) to create basic element file types such as graphic data 806, text data 808, video and audio data 810 and formatting data 812.

Specifically, an importer 804 performs the decomposition. The importer 804 to comprises available API such as a PDF Importer 804a, a PPT Importer 804b, a Word

Importer 804c and a HTML Importer 804d that are used to open files of data types “pdt”, “ppt”, “doc” and “html” respectively.

To illustrate how an importer 804 functions, the decomposition of a compound file type such as a Microsoft PowerPoint document (data file type “ppt”) is detailed. The Microsoft PowerPoint document can comprise slides having content such as images and text. The images and text will be decomposed respectively by the PPT Importer 804b into the basic element file types graphic data 806 and text data 808. The spatial arrangement of the images and text will be stored as formatting data 812. Subsequently the graphic data 806 and text data 808 will be converted into PEM data objects.

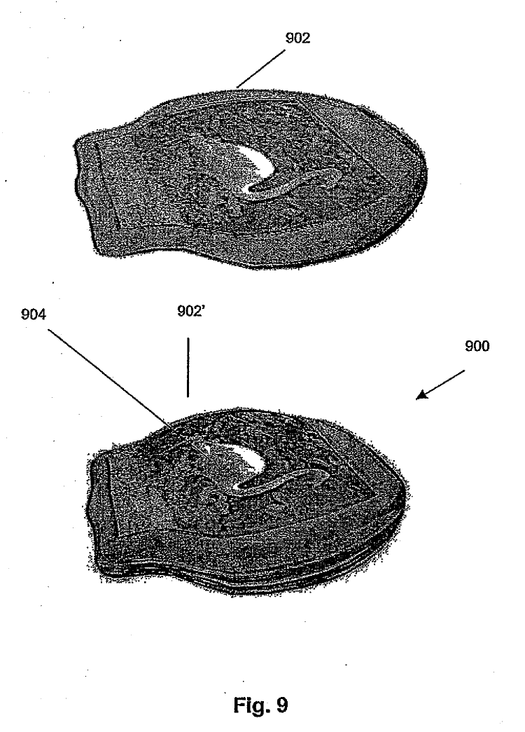

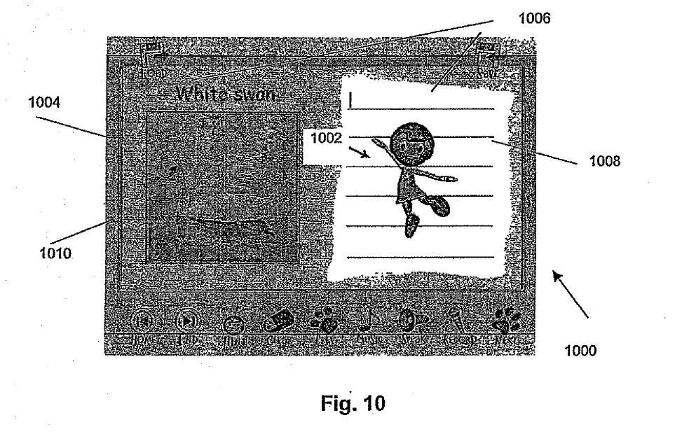

FIG. 9 illustrates one use of the Loading and Formatting Modules 208 (FIG. 2A). After a picture has been loaded by the Loading and, Formatting Modules 208 (FIG. 2A) onto an electronic document 900, the loaded picture is converted into a texture format which conforms to the surface shape of the electronic document 900, thus resulting in a picture 902′ with a modulated shape. The modulated portion 904 can also be defined to have a flat shape, i.e. a flat surface 902.

FIG. 10 shows the arrangement of multimedia objects on display pages 1006 of an electronic document through the Content Management Modules 210 (FIG. 2A).

In FIG. 10, a graphic user interface 1000, which has been provided by the Content Management Modules 210 (FIG. 2A), is used to display an electronic document 1010 comprising at least two display pages 1006. The Content Management Modules 210 (FIG. 2A) uses an object-oriented selection method to manage objects 1002, 1004 and 1008 on these two display pages 1006.

These objects 1002, 1004 and 1008 are respectively a three dimensional model, a picture and a text box. Each of these objects 1002, 1004 and 1008 exist on layers with an associated depth (z) value in three dimensional space.

The layers are arranged hierarchically and when a user selects an object 1002, 1004 and 1008 for arrangement, the object on the layer with the highest order will be selected first. The user can change the order of the layers.

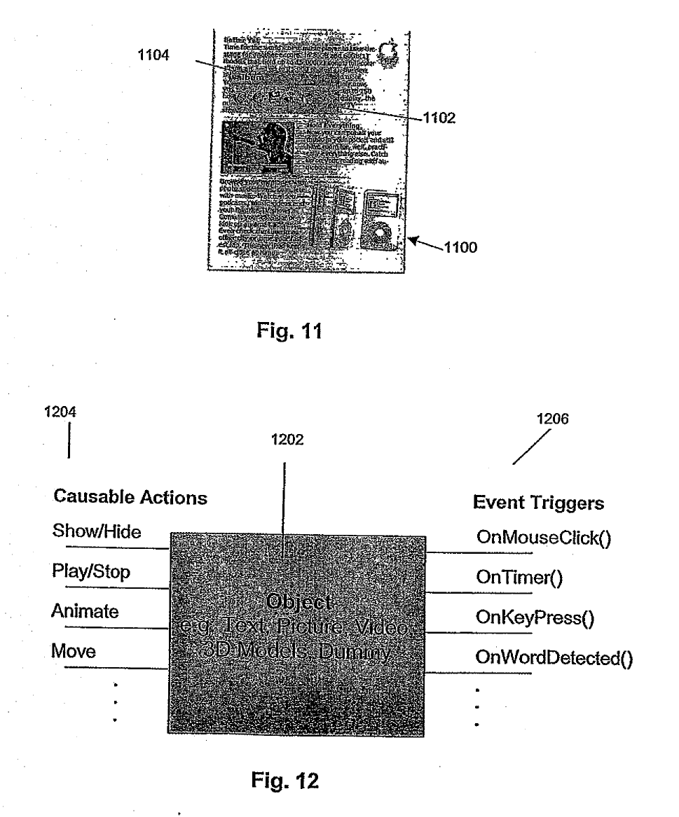

FIG. 11 shows a sub-content layer 1102 provided by the Content Management Modules 210 (FIG. 2A). The sub-content layer 1102 allows further programming on existing book objects (e.g.: text boxes, pictures and images). As shown in FIG. 11, a user has linked a word 1104 (the word “album”) on a display page 1100 of an electronic document to have a set of associated functions like text-to-speech conversion and recording of an audio clip existing on the sub-content layer 1102. Subsequently, when the word 1104 is selected, the sub-content layer 1102 appears. Thus, in this manner the sub-content layer 1102 provides a tool for users to associate functionality with selected objects on a page of an electronic document.

FIG. 12 shows Actions 1204 and Events 1206 associated with an object 1202 in an electronic document. The Action and Event Management Modules 212 (FIG. 2A) provide a mechanism through the use of dynamic links that gives a user the capability of associating Actions 1204 and Events 1206 to all objects 1202 present in the electronic document to be created. These objects 1202 include pictures, text, multimedia files like videos, 3D models and dummy objects. Actions 1204 are a set of pre-defined “actions”, such as the playing and stopping of a video clip, provided by the object 1202, the “actions” being invoked by Events 1206 from other objects 1202. Events 1206, such as using a mouse pointer to select an object 1202 or when a video has finished playing, are a set of triggers that will invoke an associated Action 1204 on another object 1202. While only some Actions 1204 and Events 1206 have been shown in FIG. 12, other Actions 1204 and Events 1206 can be created and associated with a desired object 1204.

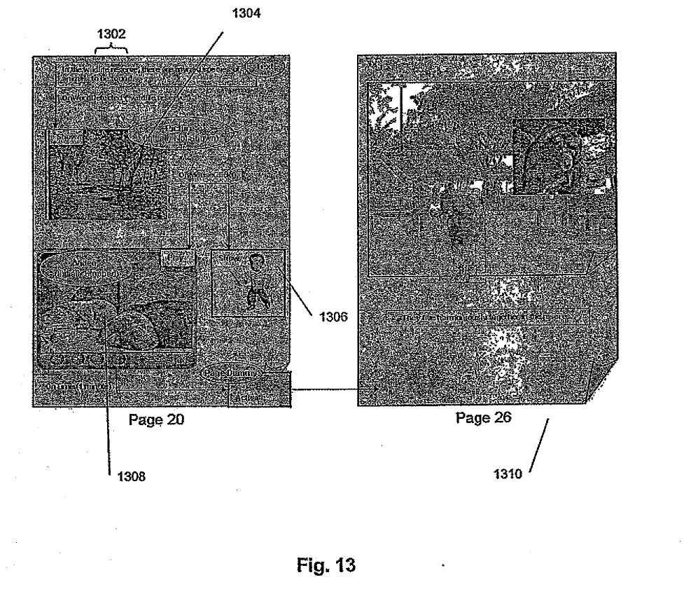

FIG. 13 illustrates several uses of the Action and Event Management Modules 212 (FIG. 2A). An object 1302, i.e. the phrase “wildlife reserve”, can be defined to trigger an Event through the OnWordDetected( ) Effect trigger 1206 (FIG. 12). The event that occurs is the showing of a picture 1304. When the picture 1304 is selected using the mouse pointer, the OnMouseClick( ) Effect trigger 1206 (FIG. 12) will cause a video 1308 to start playing and will also cause another picture 1306 to be shown. After the video 1308 has played for a specified duration, the OnTimer( ) Effect trigger 1206 (FIG. 12) will be invoked and a second display page 1310 will be loaded. Thus, objects 1302, 1304, 1306, 1308 and 1310 will have the capability of interacting with each other creating an interactive and dynamic electronic document.

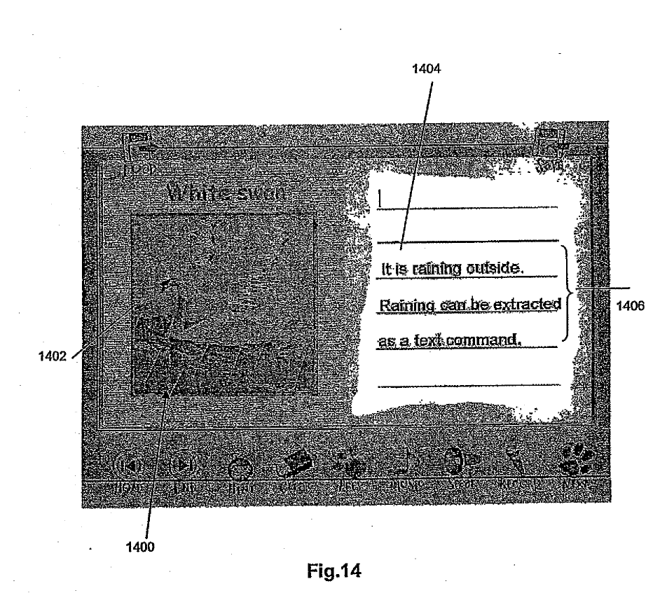

FIG. 14 illustrates how the Media Filtering Modules 232 (FIG. 2B) work in conjunction with the Action and Event Management Modules 212 (FIG. 2A). The Media Filtering Modules 232 (FIG. 2B) will scan all contents that are present inside an electronic document to discover whether any of these contents have an associated Action and Event. When a match is found, the associated Action and Event will be executed. In FIG. 14, the Media Filtering Modules 232 (FIG. 2B) has passed all the contents of the text string 1406 and has discovered that the object 1404, i.e. the word “raining”, has an associated Action and Event. In FIG. 14, the Action and Event is to load a multimedia file 1402 depicting rain over the picture 1408 of the swan.

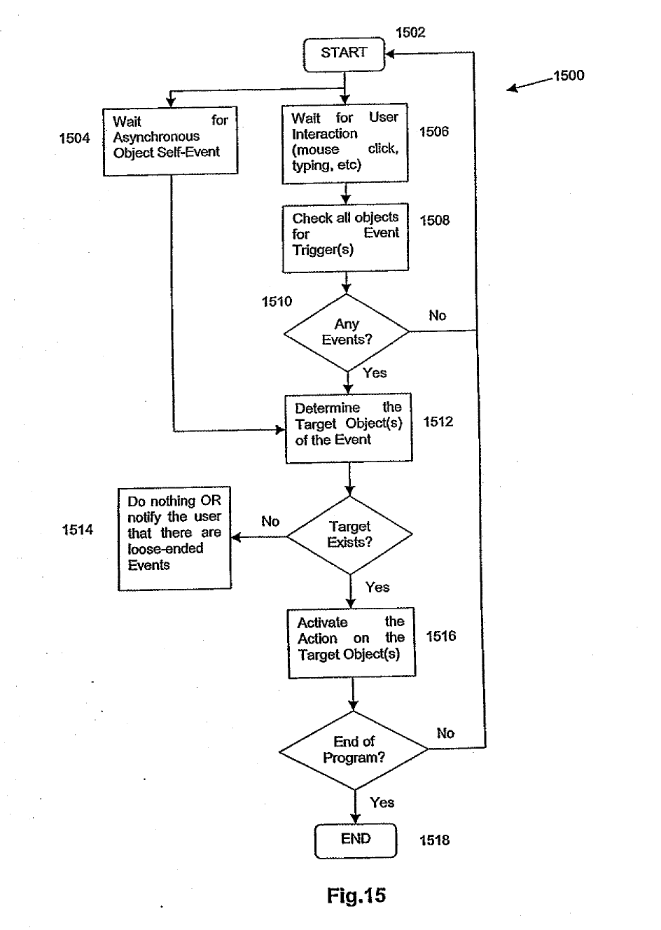

FIG. 15 illustrates a flowchart of an algorithm 1500 used by the Action and Event Management Modules 212 (FIG. 2A).

After the algorithm 1600 starts 1502, the algorithm 1500 checks whether any of the following two Events 1504, 1506 have occurred, namely User Interaction 1506 or Asynchronous Object 1504.

The User Interaction Event 1506 refers to input from a user, such as a selection of an object in an electronic document or the typing of text.

The Asynchronous Object Event 1504 refers to the presence of an object with pre-programmed Events that automatically execute without further user intervention, i.e. “self-occurring” events. The video 1308 (FIG. 13) is an example of an Asynchronous Object, where after the video 1308 has played for a specified duration, the loading of the second display page 710 (FIG. 7) automatically occurs.

If the User Interaction event 1506 has occurred, the algorithm 1500 will check at step 1508 all other objects in an electronic document for Event triggers, i.e. whether any of the other objects have associated Events that are triggered based on this particular User Interaction. If there are no associated Events, the algorithm 1500 returns through step 1510 to the start 1502 of the algorithm 1500 to subsequently repeat the check for Events 1504 and 1506.

On the other hand, if there are associated Events, the algorithm 1500 proceeds through step 1510 to step 1512 wherein the algorithm 1500 determines the target objects of the associated Events.

If the target objects do not exist, the user will be accordingly notified in step 1514. On the other hand, if the target objects exist, the corresponding Action associated with the target objects will be activated at step 1516. The target objects can be other objects present in the electronic document or may even be the objects with the associated Events themselves.

Returning to the occurrence of the User Interaction event 1506, it will be appreciated that because the User Interaction event 1506 associated events are “self-occurring” (as described earlier), steps 1506, 1508 and 1510 are not required. The algorithm will simply proceed to the step 1512 and follow a similar sequence as detailed with reference to the steps 1514 and 1516.

After the step 1516 has been executed, the algorithm 1500 will return to the start 1502 if the user still invokes the Action and Effect Modules 600 (FIG. 6). Otherwise, the algorithm 1500 will end at step 1518.

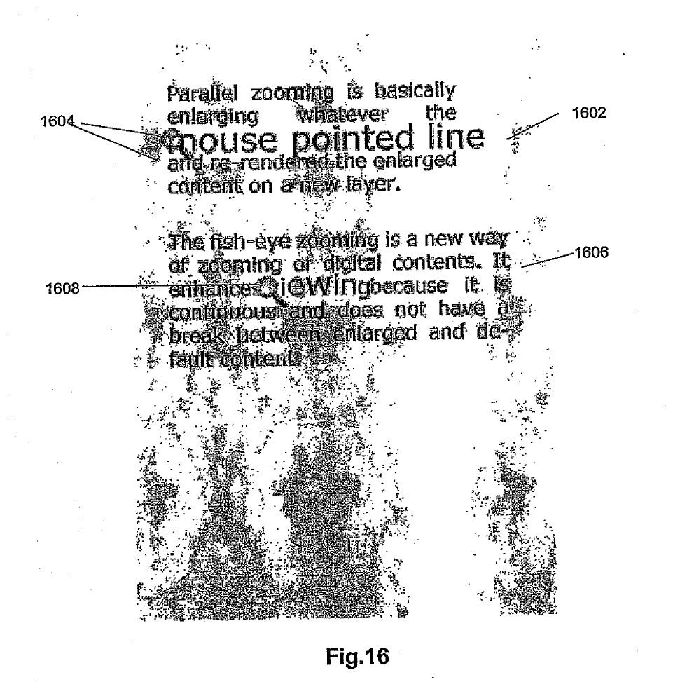

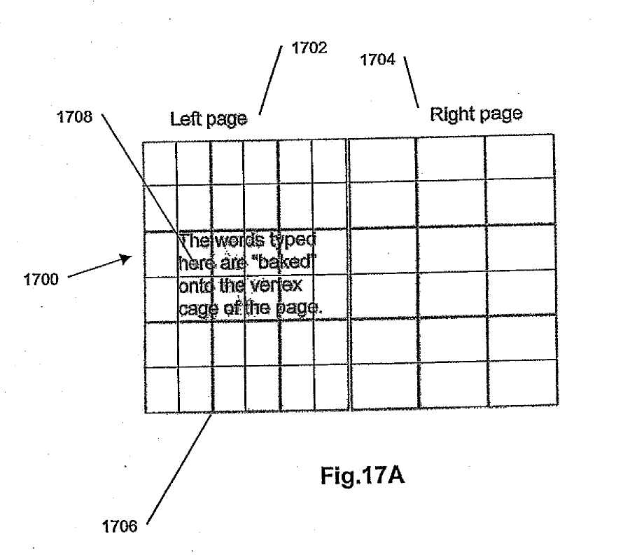

FIG. 16. illustrates how the Viewing Enhancement Modules of the Media Presentation Modules 234 (FIG. 2B) enlarge text. The Viewing Enhancement Modules allow three ways to enlarge text, namely parallel zoom 1602, fish-eye zoom 1604 and modular zoom (not shown).

The parallel zoom 1602 enlarges all the text on one or more lines 1604 selected by a mouse and re-renders the enlarged text on a new layer.

The fish-eye zoom 1606 enlarges text in a manner such that the centre portion 1608 of the selected text has the largest degree of enlargement, while the degree of enlargement applied to the remaining portion of the selected text decreases as the text is further away from the centre portion. Thus viewing of the enlarged text is enhanced because there is no sudden change from the normal sized text that is on the left and right sides of the selected text where the fish-eye zoom 904 is applied.

The modular zoom enlarges text of a selected paragraph, or any pre-selected area by a user.

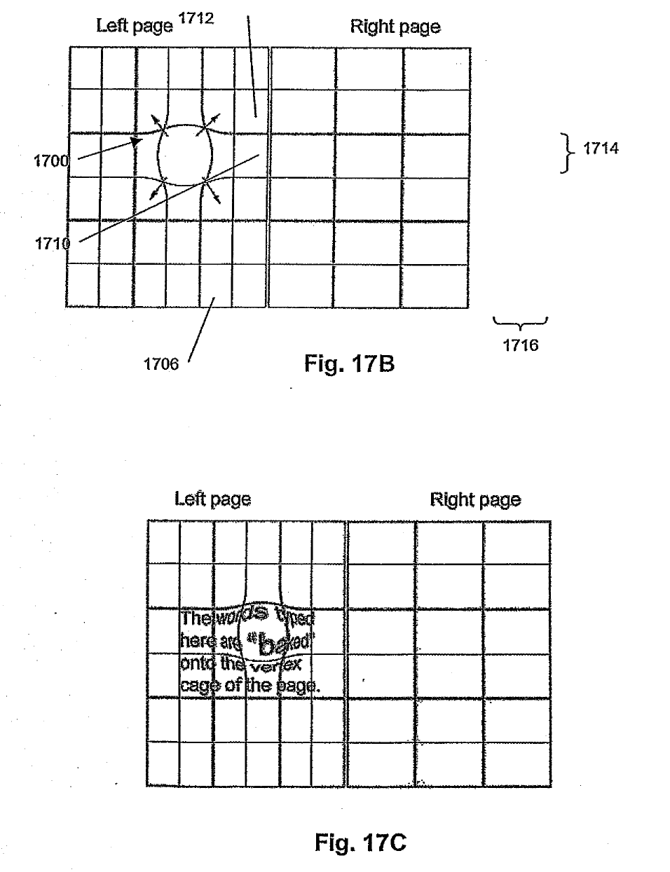

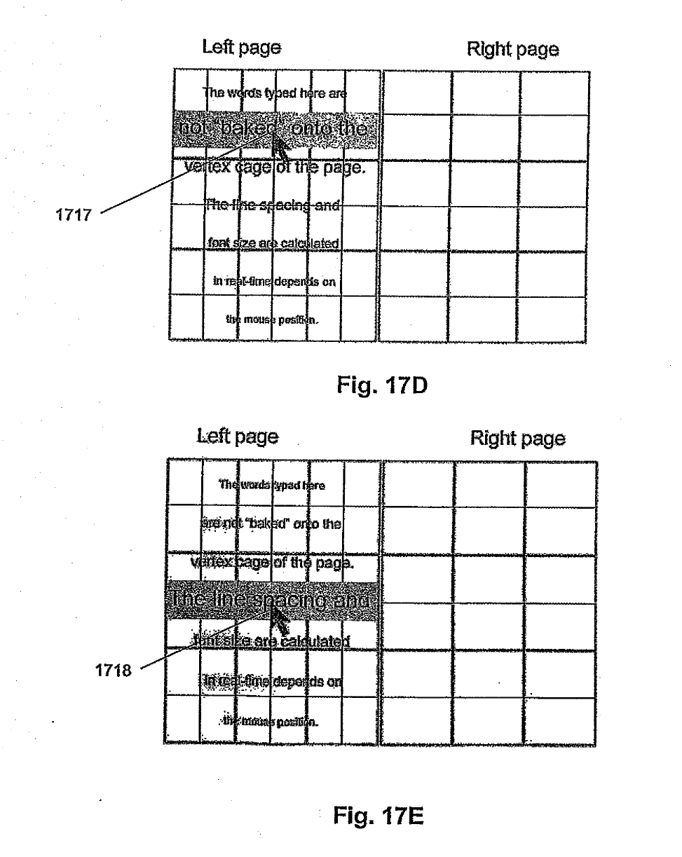

FIGS. 17A to 17C show how fish-eye zoom is performed using the Viewing Enhancement Modules of the Media Presentation Modules 234 (FIG. 2).

FIG. 17A illustrates two display pages 1702 and 1704 of an electronic document 1700. A vertex cage 1706 has been created on both the display pages 1702 and 1704. Text 1708 has been embedded unto the pages 1702 and 1704 using the Media Embedment and Page Binding Modules 218 (FIG. 2)

When the fish-eye zoom is used, a point 1710 selected by a mouse pointer (not shown) forms the center of the zoom, as shown in FIG. 17B. The radius of the fish-eye zoom from the point 1710 can be adjusted. The shape of the portion 1712 of the vertex cage 1706 around the point 1710 will be distorted according to the distance each edge of the portion 1712 is disposed from the point 1710, where the degree of distortion is inversely proportional to the distance the edge is from the point 1712.

Another method to achieve fish-eye zoom is to define a row 1714 or a column 1716 of the vertex cage 1706 as the centers of the fish-eye zoom rather than the point 1710.

FIGS. 17D and 17E show how fish-eye zoom can be combined with parallel zoom to enlarge text. Rows 1717 and 1718 have been defined to be the rows where fish eye zoom and parallel zoom are to be applied. While the degree of enlargement applied to each row of text decreases as each row becomes further away from the rows 1717 and 1718, the same respective degree of enlargement will be employed to all the text within the same row.

Another way to enlarge text (not shown) is to bring each page of the electronic document nearer to a “virtual camera” effected by the Viewing Enhancement Modules of the Media Presentation Modules 234 (FIG. 2B). A view matrix and a projection matrix are used to define a point on a “virtual” plane in proximity with the electronic document. The point on the “virtual” plane then becomes the viewing position from which a user views text on the page. There is thus a distance between the viewing position and the text and a direction from which viewing occurs. To enlarge text, the view matrix and the projection matrix values are adjusted accordingly.

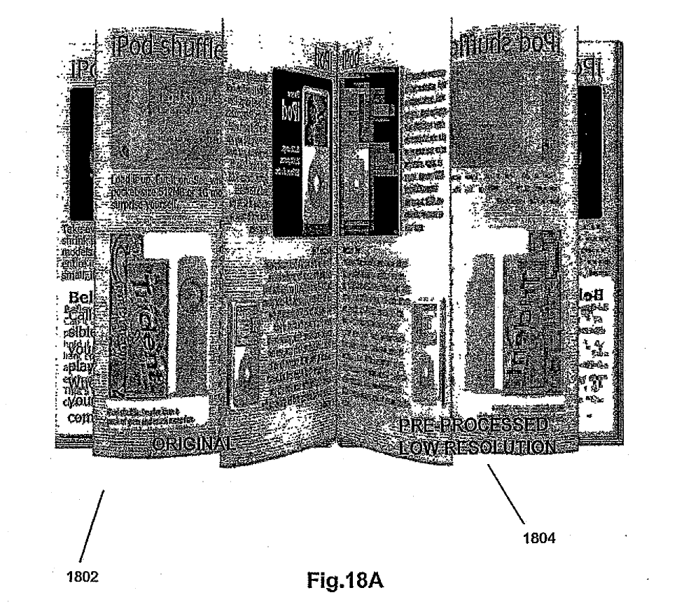

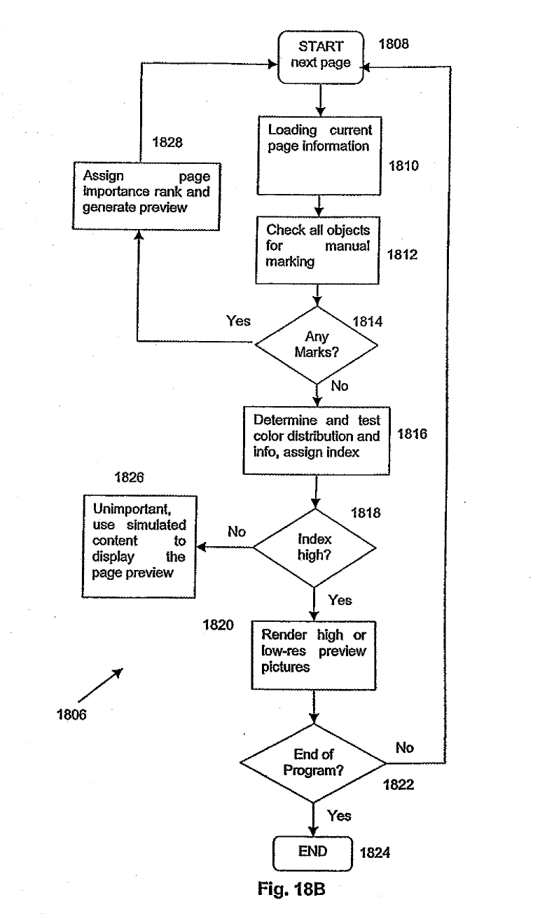

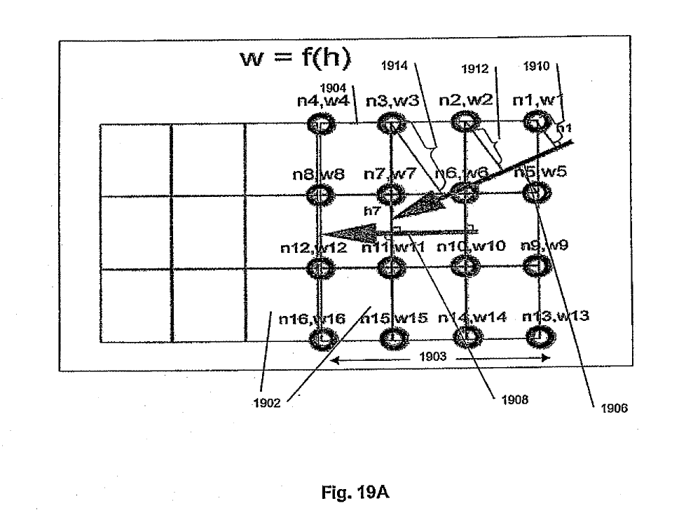

FIG. 18A illustrates the fast multi page flip style of the Media Presentation Modules 234 (FIG. 2B) in use. The fast multi page flip style is used when specific information or a specific page is desired to be located. For the fast multi-page flip style, an Artificial Intelligent Data Filter, which works in conjuction with the Loading and Formatting Modules 208 (FIG. 2A), is implemented to identify key information on a page that is necessary for instant page recognition, while simultaneously discarding the unnecessary information. This discernment of information reduces the computing resources required to access an electronic document having a substantial number of pages.

FIG. 18B shows a flowchart of an algorithm 1806 employed by the Artificial Intelligence Data Filter of the Loading and Formatting Modules 208 (FIG. 2A).

The algorithm 1806 starts 1808 as each page of the electronic document is loaded.

In step 1810, information on the current page is loaded. A page is scanned in its original resolution 1802 (FIG. 18A) to determine which portions are important, such as title headings and prominent pictures, and which portions are unimportant.

In step 1812, the algorithm 1806 checks whether any objects on the page have been manually marked with a degree of importance by the user who created the electronic document. If such manual markings are present, the algorithm 1806 proceeds to step 1828 where a page importance rank is assigned to the present page and a preview of the page generated according to the page importance rank. If such manual markings are not present, the algorithm 1806 proceeds to step 1816.

In step 1816, the algorithm 1806 retains the areas with high colour contrast and high color saturation while removing the areas with uniform colour contrast and low colour saturation. An index is then accordingly assigned to each of these areas.

In step 1818, the assigned index is compared against a default index. If the assigned index exceeds the default index, then a high resolution 1802 (FIG. 18A) preview picture or a low resolution 1804 (FIG. 18A) preview picture is rendered and stored in step 1820. or low resolution (based on the test index value) preview image is rendered and stored. On the other hand, if the assigned index is smaller than the default index, a simulated picture is used to display the preview image.

At step 1822, the algorithm determines if preview images have been created for all the pages in the electronic document. If there are still pages where preview images have not been created, the algorithm 1806 returns to the start 1808. Otherwise, the algorithm 1806 ends at step 1824.

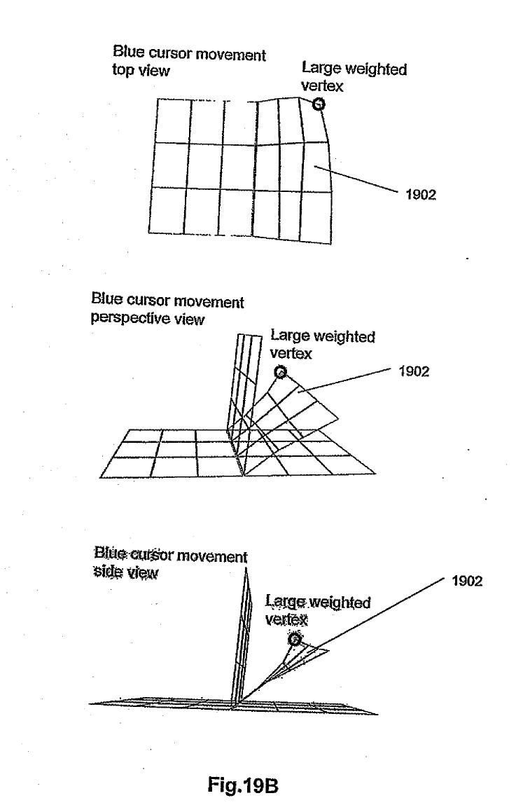

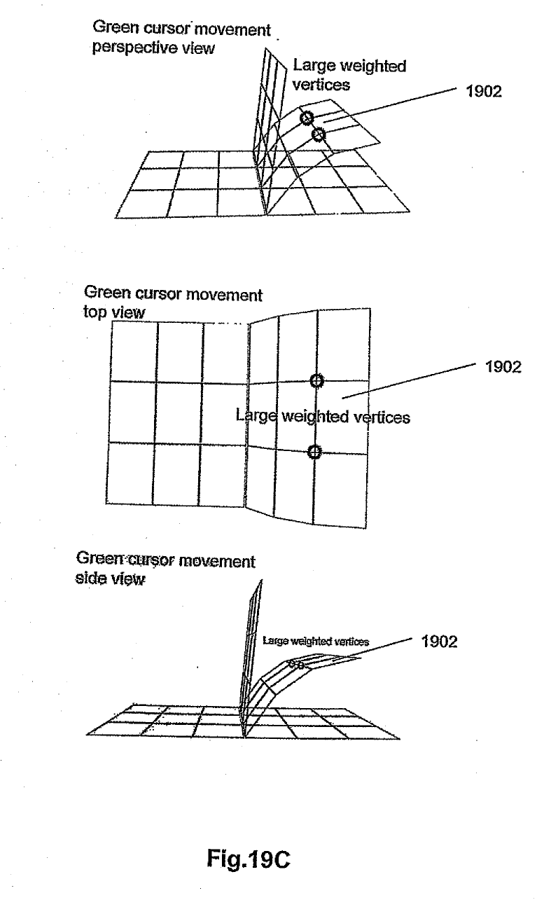

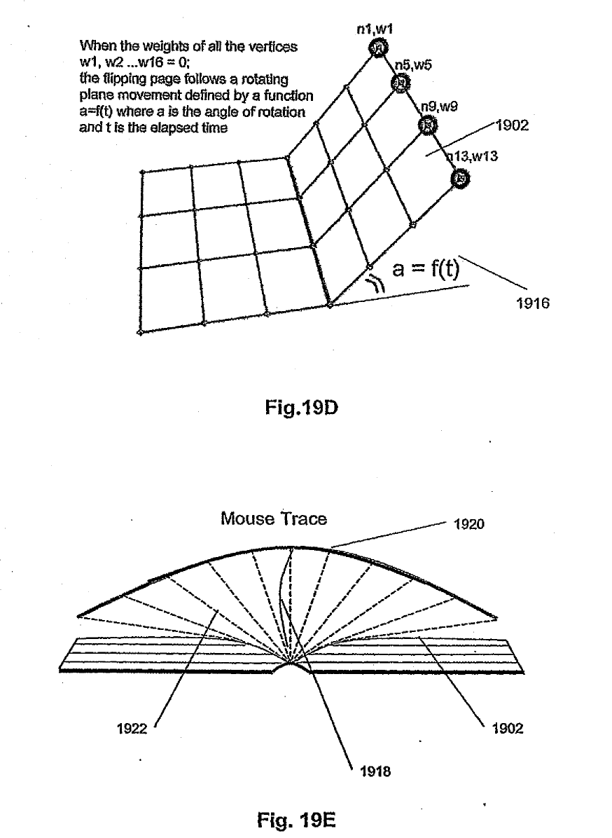

FIGS. 19A to 19D illustrate how the Page Flipping Module of the Media Presentation Module 234 (FIG. 2) is used to modulate the manner in which each electronic document display page 1902 flips through weighted vertex manipulation.

A vertex cage 1904 has been created on the display pages 1902. Vertex points, (n1, w1), (n2, w2), . . . and (n16, w16) are defined (as circled) on the vertex cage 1904 of the right display page 1902.

Each vertex point has a corresponding “weight”. The “weight” associated with each vertex point defines the manner in which the right display page 1902 flips.

One way to assign a “weight” to each vertex point is through the function

wₓ=f(hₓ)

where w is the assigned ‘weight’ and h is the magnitude of the perpendicular distance (1910, 1912, 1914) the vertex point is disposed from a path (1906 and 1908) traced across the right display page 1902 by a mouse pointer. The subscript “x” refers to the vertex point (n1, w1), (n2, w2), . . . and (n16, w16) in question. Weights assigned by the function wₓ=f(hₓ) is also affected by the length of the path 1906 and 1908 traced. The function f can then be customised as desired by the user.

As an illustration, FIG. 19B shows the manner in which the right display page 1902 flips when the path 1906 is employed to assign weights to the vertex points on the right display page 1902. FIG. 19C then shows the manner in which the right display page 1902 flips when the path 1908 is employed to assign weights to the vertex points on the right display page 1902.

FIG. 19D illustrates the manner in which the right display page 1902 will flip when all the vertex points have equal weight. The right display page 1902 will then flip according to the function

a=f(t)

where a is the angle 1916 of rotation and t is the elapsed time. The elapsed time is dependent on the “frames per second” (FPS) of a computer screen, i.e. the rate at which graphics are rendered onto a computer screen. The elapsed time is the time difference between current rendered frame and the previous rendered frame. For example, if a computer screen renders graphics at a rate of 25 FPS, then the elapsed time will be 0.04 seconds (1 second divided by 25).

FIG. 19E shows another method to modulate the manner in which the right display page 1902 can be flipped. In this other method, a curved path 1920 is drawn using the mouse pointer to define interpolated motion flipping paths 1922 for the right display page 1902. As the right display page 1902 flips, the right display page 1902 curves along its width 1903 so that the edge of the right display page 1902 follows the curved path 1902. A side view of the resulting curved right display page 1902 is shown as reference numeral 1918.

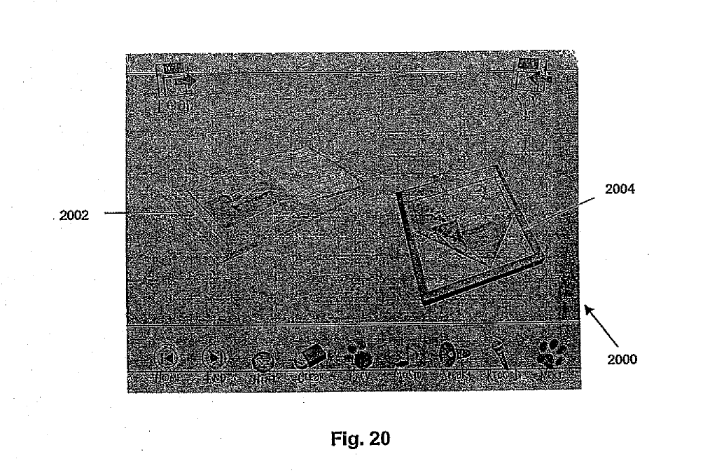

FIG. 20 shows a graphic user interface 2000 provided by the Content Management Modules 210 (FIG. 2A). A flipping book electronic document 2002 and a folding book electronic document 2004 are shown. The electronic authoring tool 200 (FIG. 2A) allows a user to transfer the contents from the flipping book electronic document 2002 to the folding book electronic document 2004 by simply performing a mouse “drag and drop” transfer. Similarly, the electronic authoring tool 200 (FIG. 2A) allows a user to transfer the contents from the flipping book electronic document 2004 to the folding book electronic document 2002 by simply performing a mouse “drag and drop” transfer. The “drag and drop” transfer is achieved by the electronic authoring tool 200 (FIG. 2A) copying the entire page structure and page information from the source electronic document 2002, 2004 to the destination electronic document 2004, 2002.

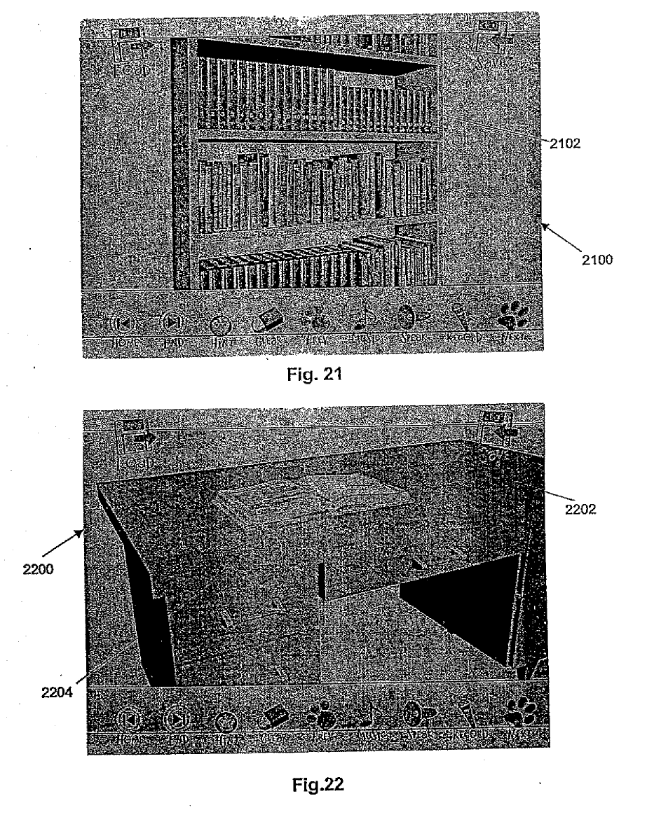

The electronic authoring tool 200 (FIG. 2A) also provides means to create visual electronic storage objects to carry create created electronic documents. FIGS. 21 and 22 illustrate two such electronic storage objects as described below.

FIG. 21 shows a graphic user interface 2100 depicting a visual electronid storage object in the form of an electronic library 2102. The electronic library 2102 acts as an electronic archive to store created electronic documents 2106. Any electronic document 2106 can be retrieved through the use of a mouse pointer.

FIG. 22 shows a graphic user interface 2200 depicting a visual storage object in the form of an electronic table 2202. The electronic table 2202 acts as an electronic holder to place a created electronic document 2204. While only one electronic document 2204 has been shown, it will be appreciated that several electronic documents 2204 can be placed onto the electronic table 2202, wherein any of the electronic documents 2204 can be retrieved through the use of a mouse pointer.

Accordingly, it will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1.-33. (canceled)

34. An authoring tool for creating an electronic document, the authoring tool comprising:
a template module for selecting a template for the electronic document, the template comprising one or more display pages;
a content management module for arranging one or more different media files on two or more of the display pages with selected interrelationships between the media files;
a generating module for creating an electronic page file for each display page, wherein each electronic page file contains data representing a vertex grid structure and wherein the media files are mapped to one or more vertices of the vertex grid structure for embedding the media files, the electronic page file further comprising data representing the selected interrelationships; and
a binding module for electronically binding the respective electronic page files so as to create a vertex grid based electronic document.

35. The authoring tool as claimed in claim 34, wherein the vertex grid structure of each electronic page file comprises a plurality of layers for forming hierarchical relationships between content objects of each display page.

36. The authoring tool as claimed in claim 34, wherein the interrelationships between the media files include one or more of a group consisting of dynamic links, triggering events, playing or stopping of video or audio clips and operations executed by peripherally connected devices, wherein the peripherally connected devices include at least one device selected from a group consisting of a keyboard, a mouse, and a network or a wireless device.

37. The authoring tool as claimed in claim 36, wherein the trigger events include one or more of a group consisting of a time based, a mouse click based, a text input based, a text deletion based, a media file or portion of media file detection based, and a key stroke based trigger event and the peripherally connected devices include one or more of a group consisting of a keyboard, a mouse, and a network or a wireless device.

38. The authoring tool as claimed in claim 34, wherein
each display page is capable of motion including one or more of a group consisting of flipping, rolling, sliding and folding through modulation of the vertex grid structure,
modulation of the vertex grid structure causes the embedded media files to be modulated in the same manner as the vertex grid structure; and
the modulation of the vertex grid structure occurs in real time.

39. The authoring tool as claimed in claim 34, further comprising a media filtering module for processing the media files, wherein the media filtering module allows a retention of the original format of the media files after the media files are mapped to the vertex grid structure.

40. The authoring tool as claimed in claim 34, further comprising:
a rendering module for controlling the rendering of the media files, wherein the rendering module provides tools to control one or more of a group consisting of vertex and pixel shader, transparency, overlay and shading effects;
a loading module for allowing a preview of the display pages of the electronic document by retaining the resolution of electronic page files with higher importance and reducing the resolution of electronic page files with lower importance; and
a media presentation module for performing enlargement of selected text, wherein the centre portion of the selected text has the largest degree of enlargement and the degree of enlargement applied to the remaining portion of the selected text decreases as the text is further away from the centre portion of the selected text.

41. The authoring tool as claimed in claim 34, wherein the content management module provides functions including one or more of a group consisting of a graphic user interface; addition of text-boxes, drawing pads and three dimensional models; text editing tools; recording of an audio and/or video clip; and dragging and dropping of the media files into the electronic document.

42. The authoring tool as claimed in claim 41, wherein the graphic user interface provides for one or more of a group consisting of authoring, viewing of the media files, and management of the media files placed in the electronic document.

43. The authoring tool as claimed in claim 41, wherein the text editing tools provide for one or more of a group consisting of word error checking, change tracing, selection of different font sizes, book marking, text alignment and picture zooming.

44. The authoring tool as claimed in claim 34, wherein the display pages, including the media files mapped to the vertex grid structure, are displayed in real time.

45. The authoring tool as claimed in claim 34, wherein the interrelationships between the media files are modifiable in real time.

46. The authoring tool as claimed in claim 34, wherein
the interrelationships comprise dynamic and static interrelationships between the media files;
the dynamic interrelationships comprise trigger event based interrelationships; and
one or more causable actions associated with one media file are invoked based on trigger events.

47. The authoring tool as claimed in claim 46, wherein the dynamic interrelationships between the media files include one or more of a group consisting of dynamic links, trigger events, playing or stopping of video or audio clips and operations executed by peripherally connected devices.

48. The authoring tool as claimed in claim 47, wherein the trigger events include one or more of a group consisting of a time based, a mouse click based, a text input based, a text deletion based, a media file or portion of media file detection based, and a key stroke based trigger event.

49. The authoring tool as claimed in claim 47, wherein the peripherally connected devices include one or more of a group consisting of a keyboard, a mouse, and a network or a wireless device.

50. The authoring tool as claimed in any claim 34, wherein the media files include one or more of a group consisting of a text file, a picture file, a video file, a 3-D graphics file, a sound file, and a multi-media file.

51. A method for creating an electronic document, the method comprising the steps of:
selecting a template for the electronic document, the template comprising one or more display pages;
arranging one or more different media files on two or more of the display pages with selected interrelationships between the media files;
creating an electronic page file for each display page, wherein each electronic page file contains data representing a vertex grid structure and wherein the media files are mapped to one or more vertices of the vertex grid structure for embedding the media files, the electronic page file further comprising data representing the selected interrelationships; and
electronically binding the respective electronic page files so as to create a vertex grid based electronic document.

52. The method as claimed in claim 51, wherein the interrelationships comprise dynamic and static interrelationships between the media files.

53. The method as claimed in claim 52, wherein
the dynamic interrelationships comprise trigger event based interrelationships,
one or more causable actions associated with one media file are invoked based on trigger events; and
the dynamic interrelationships between the media files include one or more of a group consisting of dynamic links, trigger events, playing or stopping of video or audio clips and operations executed by peripherally connected devices.

54. The method as claimed in claim 53, wherein the trigger events include one or more of a group consisting of a time based, a mouse click based, a media file or portion of media file detection based, and a key stroke based trigger event.

55. The method as claimed in claim 53, wherein the peripherally connected devices include one or more of a group consisting of a keyboard, a mouse, and a network or a wireless device.

56. The method as claimed in claim 53, wherein the media files include one or more of a group consisting of a text file, a picture file, a video file, a 3-D graphics file, a sound file, and a multi-media file.

57. A data storage medium having stored thereon computer code means for instructing a computer to execute a method for creating an electronic document, the method comprising the steps of:
selecting a template for the electronic document, the template comprising one or more display pages;
arranging one or more different media files on two or more of the display pages with selected interrelationships between the media files;
creating an electronic page file for each display page, wherein each electronic page file contains data representing a vertex grid structure and wherein the media files are mapped to one or more vertices of the vertex grid structure for embedding the media files, the electronic page file further comprising data representing the selected interrelationships; and
electronically binding the respective electronic page files so as to create a vertex grid based electronic document.

58. A data storage medium having stored thereon computer code means for instructing a computer to display an electronic document, the electronic document comprising:
one or more display pages;
one or more different media files on two or more of the display pages with selected interrelationships between the media files; and
an electronic page file for each display page, wherein each electronic page file contains data representing a vertex grid structure and wherein media files are mapped to one or more vertices of the vertex grid structure for embedding the media files, the electronic page file further comprising data representing the selected interrelationships,
wherein the respective electronic page files are bound together so as to form a vertex grid based electronic document.
